(19) United States
(12) Patent Application Publication
(10) Pub. No.: US 2009/0159657 A1
(43) Pub. Date: Jun. 25, 2009

(54) Contactless integrated circuit card system

(75) Inventors: Chien-Chow Chen, Taipei (TW); Chih-Nung Wang, Taipei (TW)

Correspondence Address: BACON & THOMAS, PLLC, 625 SLATERS LANE, FOURTH FLOOR, ALEXANDRIA, VA, 22314-1176, US

(73) Assignee: Taisys Technologies Co., Ltd., Taipei (TW)

(21) Appl. No.: 12/000,974

(22) Filed: Dec. 19, 2007

(51) Int. Cl. G06F 17/00; G06K 19/06

(52) U.S. Cl. 235/375; 235/492

(57) ABSTRACT

A contactless integrated circuit card system for communicating with a card reader is disclosed. The contactless integrated circuit card system includes an integrated circuit chip for performing contactless identification; a main antenna connected to the integrated circuit chip for transmitting signals to and from the card reader; and at least one open-circuit antenna disposed on the main antenna for increasing gain of the main antenna so that the electromagnetic induction of the main antenna is enhanced.

### FIELD OF THE INVENTION

The present invention relates to a contactless integrated circuit card system, and more particularly, to a contactless integrated circuit card system for use in radio frequency identification.

### BACKGROUND OF THE INVENTION

In recent years, the RFID (radio frequency identification) system has been introduced into the fields of art such as an automatic ticket checker used in the train station, security system for checking people going to enter or exit from a building, electronic money system, etc. Usually, the RFID system includes a contactless integrated circuit card and a reader/writer to write and read data to and from the integrated circuit card. The RFID system adopts the theory of electromagnetic induction. Meanwhile, an electromagnetic field radiated from a loop antenna provided at the reader/writer is coupled by the electromagnetic induction to a loop antenna provided at the integrated circuit card to provide communications between the integrated circuit card and reader/writer.

Generally, a loop antenna provided at the reader/writer should be able to radiate an electromagnetic field having a certain degree of magnetic strength in order to assure a satisfactory range of communications between the integrated circuit card and reader/writer. Generally, the loop antenna for the reader/writer includes a loop coil formed from a plane winding of a conductor; and the loop coil is formed to have winding sections thereof, opposite to each other across the center of the loop coil, disposed symmetrically to be equal in interval and width to each other. Moreover, a loop antenna for the reader/writer should not be installed as it is to a housing made of metal because it will not normally operate due to the influence of an eddy current. If a loop coil is installed in a metallic housing, the loop antenna for the reader/writer cannot efficiently radiate any electromagnetic field to the integrated circuit card, and thus the range of communications between the integrated circuit card and reader/writer is narrow. Additionally, if a resin-made housing is used to house the loop coil, a spacer should be disposed between an electric circuit board inside the resin-made housing and the loop antenna to prevent any noise from being electromagnetically induced, which will lead to an increased thickness of the housing. In general, a small portable-type electronic device is limited in size to assure its portability. Therefore, any well worked-out disposition of the loop coil in a space inside the housing will not effectively solve the problems in assuring a space for the loop coil installed inside the housing, that is enough to inhibit the electromagnetic field radiated from the loop antenna from adversely affecting the electronic circuit board and the like disposed near the inner wall of the housing as well as to prevent the metallic housing from affecting the loop antenna. Accordingly, metal containers and RFID system won't mix too well, unless you know how. For solving the problem, there are several types of antenna for RFID are disclosed.

An antenna for RFID (Radio Frequency Identification) configured to be electrically connected to an integrated circuit chip or capacitor and configured to be affixed to an article is disclosed in U.S. Pat. No. 7,161,542. The antenna includes a planar conductive member having a first side configured to be mounted on the article; and a coil body configured with coil turns and mounted on or at a second side which is opposite to the first side of the conductive member, wherein the conductive member shields the coil body from the article. FIG. 1 and FIG. 2 illustrate an antenna for RFID according the prior art of U.S. Pat. No. 7,161,542. The conductive member 14a uses a sheet, plate, or foil made of a conductive material. Moreover, as long as the conductive member 14a has conducting properties, it is possible for the member 14a to be a conductive paint film obtained by applying a conductive ink to the back of a nonconductive sheet, plate, or foil 16 and drying it as shown in the enlarged view in FIG. 2. The spiral coil body 14b uses a conventional coil body having been used so far. The coil body 14b is formed by adjusting the number of turns and/or spiral diameter of the coil body 14b so that a predetermined characteristic value can be secured while the coil body 14b is wound on the front of the conductive member 14a. The integrated circuit chip 13 is directly adhered onto the conductive member 14a while it is connected to both ends of the coil body 14b. The antenna 14 constituted as described in U.S. Pat. No. 7,161,542, by fixing the coil body 14b to the conductive member 14a, the characteristic value generally changes. While the coil body 14b is wound on the front of the conductive member 14a, it is possible to reliably activate the tag 12 by transmitting radio waves at a predetermined frequency to the antenna 14. However, in the case of the antenna 14, the coil body 14b for actually receiving radio waves at a predetermined frequency should be wound on the front of the conductive member 14a. It is not easy to adjust the coil body 14b for the predetermined frequency. Furthermore, the characteristic value of the coil body 14b is not adjustable after the coil body 14b has been fixed on the conductive member 14a.

Other one of related arts is disclosed in U.S. Pat. No. 7,183,987. This Publication states as follows in the effect. That is, an antenna apparatus is provided which is used in a recorder and/or player to write and read data to and from a contactless integrated circuit card. As shown in FIG. 3, the antenna apparatus 30 includes a loop coil 31 to radiate an electromagnetic field for magnetic coupling with a loop coil at the integrated circuit card to send and receive data to and from the integrated circuit card, and a magnetic sheet 32 disposed to face the main side of the loop coil 31, opposite to the main side facing the integrated circuit card). Meanwhile, the loop coil 31 has the winding sections thereof opposite to each other across the center of the loop coil 31 disposed asymmetrically to be different in interval and width from each other in one direction. That is, the loop coil 31 includes an upper winding section 31a larger in interval and width in one direction, that is, a vertical direction indicated with an arrow Z in FIG. 3, and a lower winding section 31b smaller in interval and width in that direction Z. On the other hand, the magnetic sheet 32 is formed to have a rectangular shape larger than the loop coil 31 to cover the latter completely within the main side thereof. This antenna apparatus 30 has the magnetic sheet 32 attached to the main side of the loop coil 31, opposite to the main side facing the integrated circuit card. Since the loop coil 31 is formed asymmetric and the distribution of a magnetic field radiated from the loop coil 31 is controlled, it is possible to provide a wider range of communications between the integrated circuit card and R/W and also shift the position of communication in one direction. Moreover, the antenna apparatus 30 has the magnetic sheet 32 disposed to face the main side of the loop coil 31, opposite to the main side facing the integrated circuit card, and thus can enhance only the magnetic field distribution on the main side of the loop coil 31, facing the integrated circuit card. Certainly, the loop coil 31 should be designed in a specific form for solving the above problem and won't be adjustable after being set.

Although antenna apparatuses for RFID (radio frequency identification) system working in metal environments are technically feasible, in practice they are very inconvenient to implement. Meanwhile, a microwave absorbing materials are introduced for isolating firstly, and then the loop coil of the antenna is designed by means of forming stereo metric formula coils, thereby widely increasing the range of communications between the integrated circuit card and reader/writer, even though the antenna works in metal environments. However, it is not easy to control the frequency of the above antenna, and the undetermined disorderly and confused capacitance could be introduced. On the other hand, the winding coils could be disposed to change the magnetic field distribution, wherein the magnetic field distribution is transmitted in a parallel direction of the metal surface instead of in a vertical direction thereof and won't be influenced obviously by the metal. However, the entire thickness of the above antenna should be increased. For minimizing the thickness of the tag, the increasing thickness of the above conventional antenna for RFID could not be allowed in several working environments. Therefore, it needs to provide a contactless integrated circuit card system that can work in metal environments without the influences of metallic articles, thereby facilitating to be setup easily and adjustably.

### SUMMARY OF THE INVENTION

Accordingly, the prior art is limited by the above problems. It is an object of the present invention to provide a contactless integrated circuit card system that can work in metal environments without the influences of metallic articles. The contactless integrated circuit card system of the present invention could be used in metal environments, thereby preventing from the influences of the metallic article, facilitating to be setup easily and adjustably, and can rectify those drawbacks of the prior art and solve the above problems.

In accordance with an aspect of the present invention, the contactless integrated circuit card system for communicating with a card reader, includes an integrated circuit chip for performing contactless identification; a main antenna connected to the integrated circuit chip for transmitting signals to and from the card reader; and at least one open-circuit antenna disposed on the main antenna for increasing gain of the main antenna so that the electromagnetic induction of the main antenna is enhanced.

In accordance with another aspect of the present invention, the contactless integrated circuit card system used in metal environments for communicating with a card reader, includes an integrated circuit chip for performing contactless identification; a main antenna connected to the integrated circuit chip for transmitting signals to and from the card reader; a shielding member disposed between the metal environments and the main antenna for reducing interference caused by the metal environments; and at least one open-circuit antenna disposed either between or above the main antenna and the shielding member for increasing gain of the main antenna so that the electromagnetic induction of the main antenna is enhanced.

In accordance with yet another aspect of the present invention, the contactless integrated circuit card system used in metal environments for communicating with a card reader, includes an integrated circuit chip for performing contactless identification; a main antenna connected to the integrated circuit chip for transmitting signals to and from the card reader; a shielding member disposed between the metal environments and the main antenna for reducing interference caused by the metal environments; a first open-circuit antenna disposed between the main antenna and the shielding member; and a second open-circuit antenna disposed above the main antenna and the shielding member. The first open-circuit antenna and the second open-circuit antenna increase gain of the main antenna so that the electromagnetic induction of the main antenna is enhanced.

### BRIEF DESCRIPTION OF THE DRAWING

The above objects and advantages of the present invention will become more readily apparent to those ordinarily skilled in the art after reviewing the following detailed description and accompanying drawings, in which:

FIG. 1 illustrates a top view of a tag including an antenna for RFID according to the prior art;

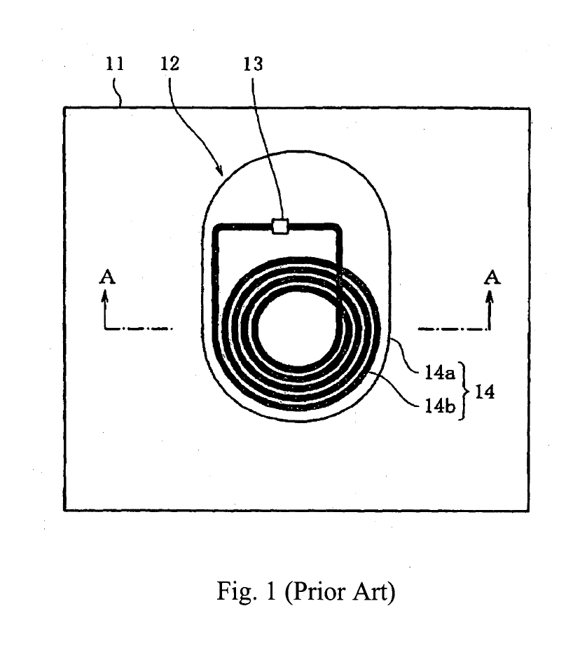

FIG. 2 illustrates a sectional view taken along the line A-A of FIG. 1;

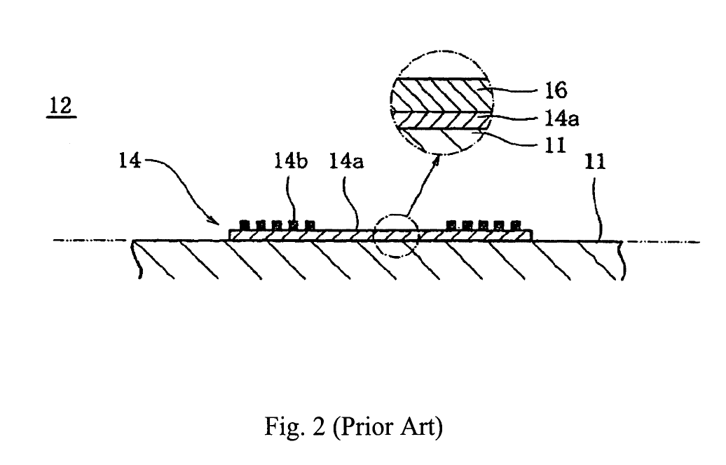

FIG. 3 illustrates an antenna apparatus used in a recorder and/or player from a contactless integrated circuit card according to the prior art;

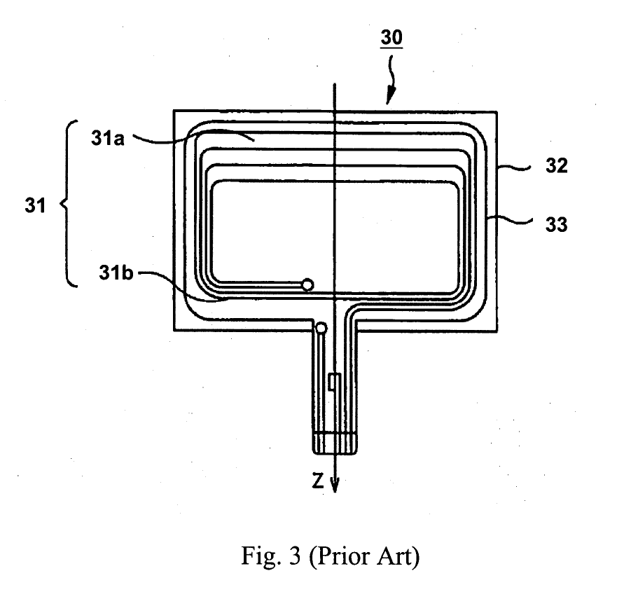

FIG. 4 illustrates a first embodiment of an antenna apparatus for a contactless integrated circuit card system used in metal environments according to the present invention;

FIG. 5 illustrates a second embodiment of a contactless integrated circuit card system according to the present invention; and

FIG. 6 illustrates a third embodiment of a contactless integrated circuit card system according to the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

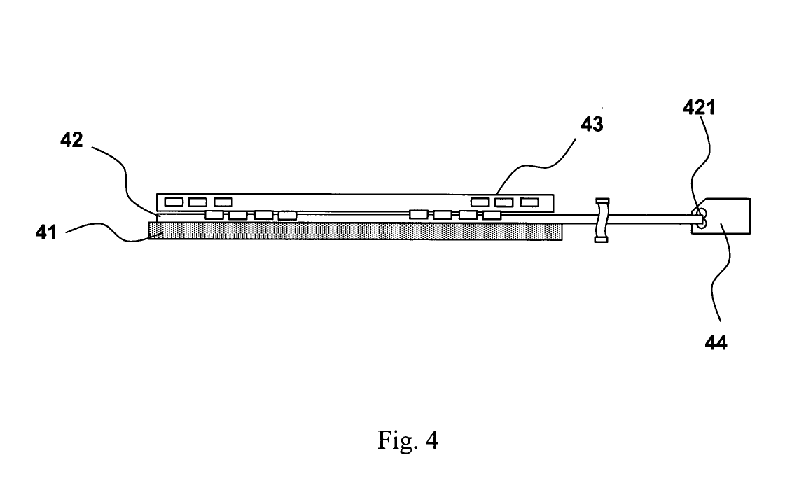

Please refer to FIG. 4. It illustrates a first embodiment of an antenna apparatus for a contactless integrated circuit card system used in metal environments according to the present invention. As shown in FIG. 4, the contactless integrated circuit card system for communicating with a card reader (not shown) includes an integrated circuit chip 44, a main antenna 42, a shielding member 41, and an open-circuit antenna 43.

The main antenna 42 is connected to the integrated circuit chip 44 via a pair of winding coil ends 421 and transmits radio frequency signals to and from the card reader so that the integrated circuit chip 44 can perform contactless identification with the card reader. The shielding member 41 is disposed between the metal environments and the main antenna 42 for reducing interference caused by the metal environments. The open-circuit antenna 43 can be disposed either between or above the main antenna 42 and the shielding member 41 for increasing gain of the main antenna so that the electromagnetic induction of the main antenna is enhanced. In this embodiment, the open-circuit antenna 43 is disposed above both the main antenna 42 and the shielding member 41.

In this embodiment, the contactless integrated circuit card system is a radio frequency identification (RFID) system. The contactless integrated circuit card system can be used in train stations as a transportation pass, security systems as an access pass, markets as a credit card, etc. The open-circuit antenna 42 is different from the main antenna 42 in that the latter is conductively bonded to the integrated circuit chip 44. In the present invention, the shielding member 41 could be a conductor in form of a sheet, plate, or foil. Certainly, the shielding member 41 could also be a soft magnetic member. Furthermore, the magnetic member could be formed of at least one of a rapidly solidifying material, casting material, rolling material, forging material, and sintering material each including at least one of an amorphous alloy, magnetic steel, silicon steel, Fe—Al alloy, and soft-magnetic ferrite. Meanwhile, the magnetic member contains a composite material of (1) fine particles or flakes of a metal or ferrite, and (2) plastic or rubber, or the magnetic member includes a film of a paint containing fine particles or flakes of a metal or ferrite. Moreover, it could be an adhesive sheet obtained by adhering a plurality of flakes, comprised of a metal or soft magnetic ferrite, to a surface of a base-material sheet comprised of plastic so that the flakes closely contact each other.

In the first embodiment of FIG. 4, the open-circuit antenna 43 is disposed over the main antenna 42. However, in practice, the open-circuit antenna 43 could be disposed between the main antenna 42 and the shielding member 41. The main antenna 42 and the open-circuit antenna 43 are insulated, and the open-circuit antenna 43 could be further obtained by covering wound coils with a cover sheet comprised of plastic and adhering the wound coils and the cover sheet together.

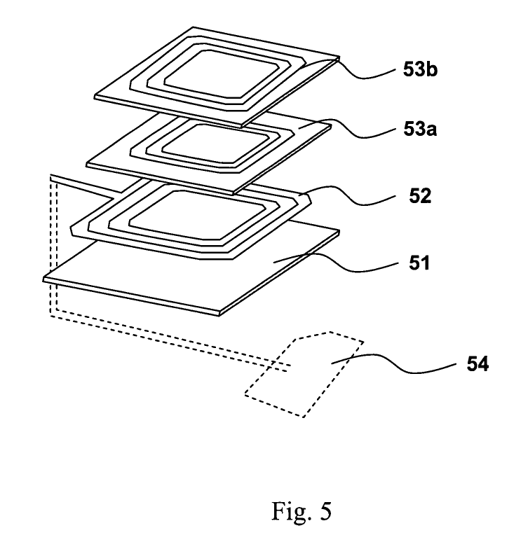

The present invention could include more than one open-circuit antenna. Please refer to FIG. 5. It illustrates a second embodiment of a contactless integrated circuit card system used in metal environments according to the present invention. In this embodiment, the contactless integrated circuit card system includes an integrated circuit chip 54, a main antenna 52, a shielding member 51, and two open-circuit antennas 53a and 53b disposed above the main antenna 52. Meanwhile, the main antenna 52 and the two open-circuit antennas 53a and 53b are shielded by the shielding member 51, and therefore, the interference caused by the metal environments can be reduced. The open-circuit antennas 53a and 53b differ from the main antenna 52 in that the latter is conductively bonded to the integrated circuit card 54.

The present invention can be used in a portable communication device such as a mobile phone, and therefore, the metal environments mentioned above may be caused by a mobile phone battery that is disposed between the shielding member 51 and the main antenna 54.

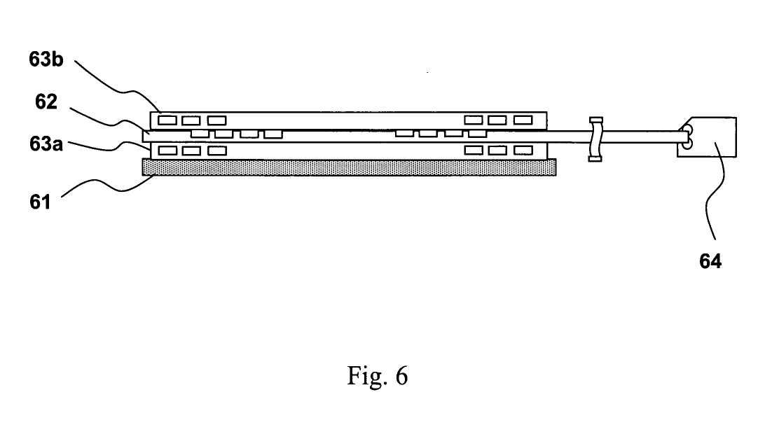

Please refer to FIG. 6. It illustrates a third embodiment of a contactless integrated circuit card system used in metal environments which includes an integrated circuit chip 64, a main antenna 62, a shielding member 61, and two open-circuit antennas 63a and 63b. The open-circuit antenna 63a is disposed between the main antenna 62 and the shielding member 61, and the open-circuit antenna 63b is disposed above both the main antenna 62 and the shielding member 61.

Meanwhile, the main antenna 62 and the two open-circuit antennas 63a and 63b are shielded by the shielding member 61, and therefore, the interference caused by the metal environments can be reduced. The open-circuit antennas 63a and 63b differ from the main antenna 62 in that the latter is conductively bonded to the integrated circuit card 64.

Similarly, the contactless integrated circuit card system is a radio frequency identification (RFID) system. In this embodiment, the contactless integrated circuit card system can be used in train stations as a transportation pass, security systems as an access pass, markets as a credit card, etc. Moreover, the main antenna 62 and the two open-circuit antennas 63a and 63b are insulated with one another. Accordingly, the entire structure of the antenna could avoid the influences of the metallic article via the shielding member and enhance the operational range of communication via the additional open-circuit antennas.

Usually, a shielding member may not be included in the contactless integrated circuit card system while the contactless integrated circuit card system is not permanently adjacent to a metallic article such as a mobile phone battery.

The main antenna and the open-circuit antenna of the present invention are planar, and each has a pair of winding coil ends. Furthermore, the winding coil ends of the open-circuit antenna are positioned in correspondence with the winding coil ends of the main antenna.

In conclusion, an open-circuit antenna of the contactless integrated circuit card system is introduced into the present invention for increasing gain of the main antenna so that the electromagnetic induction of the main antenna can be enhanced. Hence, the affect caused by the metallic article can be reduced while the contactless integrated circuit card system is placed in metal environments such as a mobile phone. Furthermore, the operational range of communication with the card reader can be increased while the contactless integrated circuit card system is not placed in any metal environments. Meanwhile, the open-circuit antenna can also be used to adjust the frequency of the main antenna according to different needs.

While the invention has been described in terms of what is presently considered to be the most practical and preferred embodiments, it is to be understood that the invention need not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A contactless integrated circuit card system for communicating with a card reader, comprising:
an integrated circuit chip for performing contactless identification;
a main antenna connected to said integrated circuit chip for transmitting signals to and from said card reader; and
at least one open-circuit antenna disposed on said main antenna for increasing gain of said main antenna so that the electromagnetic induction of said main antenna is enhanced.

2. The contactless integrated circuit card system according to claim 1, wherein said signals are radio frequency signals.

3. The contactless integrated circuit card system according to claim 1, wherein said main antenna and said open-circuit antenna are planar antennas.

4. The contactless integrated circuit card system according to claim 1, wherein said main antenna and said open-circuit antenna each comprises a pair of winding coil ends.

5. The contactless integrated circuit card system according to claim 4, wherein the winding coil ends of said open-circuit antenna are positioned in correspondence with the winding coil ends of said main antenna.

6. The contactless integrated circuit card system according to claim 1, further comprising a shielding member for reducing interference caused by metallic articles while being disposed in metal environments.

7. The contactless integrated circuit card system according to claim 6, wherein said shielding member is disposed between said metallic articles and said main antenna.

8. The contactless integrated circuit card system according to claim 7, wherein said open-circuit antenna is disposed between said main antenna and said shielding member.

9. The contactless integrated circuit card system according to claim 7, wherein said open-circuit antenna is disposed above said main antenna and said shielding member.

10. A contactless integrated circuit card system used in metal environments for communicating with a card reader, comprising:
an integrated circuit chip for performing contactless identification;
a main antenna connected to said integrated circuit chip for transmitting signals to and from said card reader;
a shielding member disposed between said metal environments and said main antenna for reducing interference caused by said metal environments;
a first open-circuit antenna disposed between said main antenna and said shielding member; and
a second open-circuit antenna disposed above said main antenna and said shielding member;
wherein said first open-circuit antenna and said second open-circuit antenna increase gain of said main antenna so that the electromagnetic induction of said main antenna is enhanced.

11. The contactless integrated circuit card system according to claim 10, wherein said signals are radio frequency signals.

12. The contactless integrated circuit card system according to claim 10, wherein said main antenna and said open-circuit antenna are planar antennas.

13. The contactless integrated circuit card system according to claim 10, wherein said main antenna, said first open-circuit antenna, and said second open-circuit antenna each comprises a pair of winding coil ends.

14. The contactless integrated circuit card system according to claim 13, wherein the winding coil ends of said first and second open-circuit antenna are positioned in correspondence with the winding coil ends of said main antenna.
